(19) United States
(12) Patent Application Publication
(10) Pub. No.: US 2007/0153011 A1
(43) Pub. Date: Jul. 5, 2007

(54) VIDEO SIGNAL CIRCUIT OF NOTEBOOK COMPUTER

(75) Inventors: Xian-Ming Wang, Shenzhen (CN); Guang-Dong Yuan, Shenzhen (CN); Da-You Chen, Shenzhen (CN); Chung-Chi Huang, Tu-Cheng (TW); Hsiu-Chang Lai, Tu-Cheng (TW); Qin Wu, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,795

(22) Filed: Sep. 28, 2006

(30) Foreign Application Priority Data
Jan. 4, 2006 (CN) 200610032699.5

(51) Int. Cl. G06F 13/14

(52) U.S. Cl. 345/520

(57) ABSTRACT

A video signal circuit of a notebook computer includes a north bridge chipset, a control module, a VGA port, an A/D converter, a selection module, and a control unit. The north bridge chipset is coupled to the control module and the selection module. The VGA port is coupled between the control module and a display device and a processing device. The A/D converter is coupled between the control module and the selection module. The selection module is coupled to an LCD of the notebook computer. The control unit is coupled to the selection module and the control module. The video signal circuit can be controlled to send a first analog and digital video signals generated by the north bridge chipset to the displaying device and the LCD respectively, or receive a second analog video signal from the processing device and display it on the LCD.

### 1. FIELD OF THE INVENTION

The present invention relates to video signal circuits, and particularly to a video signal circuit of a notebook computer.

### 2. DESCRIPTION OF RELATED ART

Conventionally an ordinary notebook computer has a liquid crystal display (LCD) for receiving and displaying a digital video signal from a north bridge chipset of the notebook computer. The notebook computer also can send an analog video signal generated by the north bridge chipset therein to a display device via a video graphics array (VGA) port thereof.

FIG. 2 shows a conventional video signal circuit 10 of a notebook computer with a north bridge chipset 12 and a VGA port 16. A digital video signal generated by the north bridge chipset 12 is transmitted to an LCD 14, and an analog video signal generated by the north bridge chipset 12 is transmitted to the VGA port 16. The VGA port 16 sends the analog video signal to a display device 18.

The conventional video signal circuit 10 can send the digital video signal and the analog video signal generated by the north bridge chipset 12 to the LCD 14 and the display device 18 respectively. However, the video circuit 10 cannot deal with an analog video signal received from a processing device like a server coupled to the VGA port 16.

What is needed, therefore, is a video signal circuit of a notebook computer which can solve the above problem.

### SUMMARY OF THE INVENTION

In one preferred embodiment, a video signal circuit of a notebook computer includes a north bridge chipset, a control module, a VGA port, an A/D converter, a selection module, and a control unit. The north bridge chipset generates a first analog video signal and a first digital video signal. The VGA port is coupled to a display device and a processing device. The control module is coupled between the north bridge and the VGA port for selectively receiving the first analog video signal of the north bridge to send it to the display device via the VGA port or receiving a second analog video signal from the processing device via the VGA port to send it to the A/D converter. The A/D converter is coupled to the control module for converting the second analog video signal to a second digital video signal. The selection module is coupled to the north bridge chipset and the A/D converter for selectively sending the first and second digital video signals to an LCD of the notebook computer. The control unit is coupled to the selection module and the control module for sending control signals thereto.

Other advantages and novel features will become more apparent from the following detailed description when taken in conjunction with the accompanying drawings, in which:

### BRIEF DESCRIPTION OF THE DRAWINGS

FIG. 1 is a block diagram of one embodiment of a video signal circuit of a notebook computer in accordance with the present invention; and

FIG. 2 is a block diagram of a conventional video signal circuit of a notebook computer.

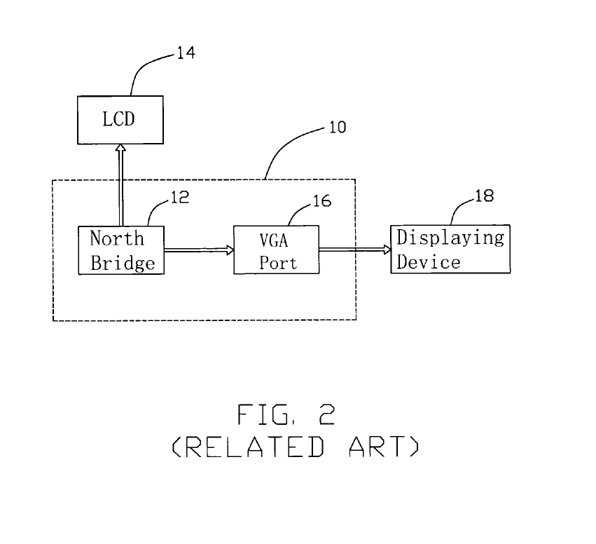

### DETAILED DESCRIPTION OF THE INVENTION

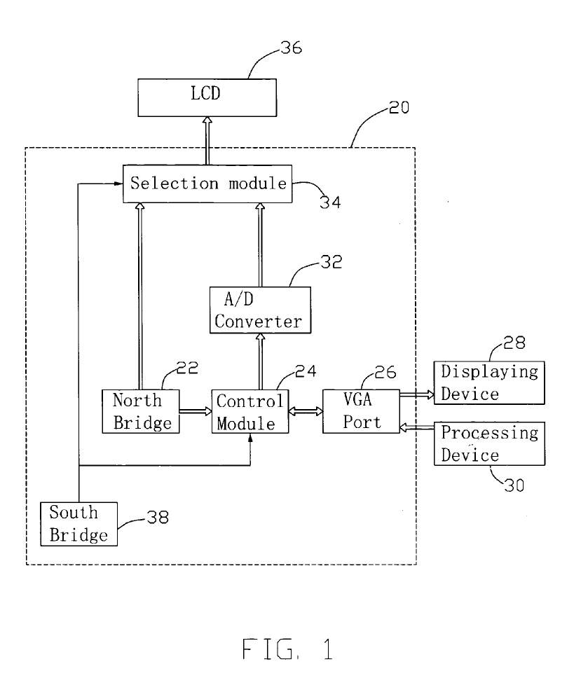

Referring to FIG. 1, a video signal circuit 20 of a notebook computer in accordance with a preferred embodiment of the present invention includes a north bridge chipset 22, a control module 24, a VGA port 26, an A/D converter 32, a selection module 34, and a control unit like a south bridge chipset 38.

The north bridge chipset 22 is coupled to the control module 24 and the selection module 34. The control module 24 is coupled to the VGA port 26 and the A/D converter 32. The VGA port 26 is coupled to a display device 28 or a processing device 30 such as a server or a desktop computer. The A/D converter 32 is coupled to the selection module 34. The selection module 34 is coupled to an LCD 36. The south bridge chipset 38 is coupled to the control module 24 and the selection module 34.

The north bridge chipset 22 generates a first analog video signal and a first digital video signal. The control module 24 receives the first analog video signal from the north bridge chipset 22 and a second analog signal from the processing device 30 via the VGA port 26. The control module 24 transmits the first analog video signal to the display device 28 via the VGA port 26 and the second analog video signal to the A/D converter 32.

The A/D converter 32 converts the second analog video signal to a second digital video signal. The selection module 34 receives the first digital video signal from the north bridge chipset 22 and the second digital video signal from the A/D converter 32. The selection module 34 selectively sends the first digital video signal and the second digital video signal to the LCD 36.

The first and the second digital video signals are transmitted via a corresponding low-voltage differential signaling (LVDS) signal line. In this embodiment of the invention, the LVDS signal line has ten wires because each of the first and the second digital video signals is ten bits. Therefore, the selection module 34 includes ten switches each having a terminal coupled to a wire of the LVDS signal line and another terminal coupled to a corresponding wire of the LCD 36.

The control module 24 includes a first switch and a second switch. The first switch has a terminal coupled to the north bridge chipset 22 and another terminal coupled to the VGA port 26. The second switch has a terminal coupled to the VGA port 26 and anther terminal coupled to the A/D converter 32. When the selection module 34 sends the first digital video signal to the LCD 36 the first switch is switch on while the second switch is switch off. When the selection module 34 sends the second digital video signal to the LCD 36 the second switch is switch on while the first switch is switch off.

The south bridge chipset 38 sends control signals to the control module 24 and the selection module 34 for controlling the first analog video signal and the first digital video signal to be sent to the display device 28 and the LCD 36 respectively, or for controlling the second analog video signal to be converted to the second digital video signal and be sent to the LCD 36.

The video signal circuit 20 of a notebook computer can send the first analog and digital video signals generated by the north bridge chipset 22 to the display device 28 and the LCD 36 respectively, or receive the second analog video signal from the processing device 30 and display it on the LCD 36.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A video signal circuit of a notebook computer, the video signal circuit comprising:
a north bridge chipset for generating a first analog video signal and a first digital video signal;
a VGA port for coupling to a display device and a processing device;
a control module coupled between the north bridge and the VGA port for selectively receiving the first analog video signal of the north bridge chipset to send it to the display via the VGA port or receiving a second analog video signal from the processing device via the VGA port;
an A/D converter coupled to the control module for receiving and converting the second analog video signal to a second digital video signal;
a selection module coupled to the north bridge chipset and the A/D converter for selectively sending one of the first and second digital video signals to an LCD; and
a control unit coupled to the selection module and the control module and sending control signals thereto for controlling the selection module to selectively send one of the first and second digital video signals to the LCD and the control module to selectively transmit one of the first analog video signal and the second analog video signal.

2. The video signal circuit as claimed in claim 1, wherein the control unit is a south bridge chipset.

3. The video signal circuit as claimed in claim 1, wherein the control module comprises:
a first switch having a terminal coupled to the north bridge chipset and another terminal coupled to the VGA port; and
a second switch having a terminal coupled to the VGA port and another terminal coupled to the A/D converter, wherein
when the selection module sends the first digital video signal to the LCD the first switch is switch on while the second switch is switch off; and
when the selection module sends the second digital video signal to the LCD the second switch is switch on while the first switch is switch off.

4. The video signal circuit as claimed in claim 1, wherein the first and second digital video signals are transmitted via a low-voltage differential signaling (LVDS) signal line having ten wires.

5. The video signal circuit as claimed in claim 4, wherein the selection module comprises ten switches, each of the switches has a terminal coupled to a corresponding one of the wires of the LVDS signal line and another terminal coupled to a corresponding wire of the LCD.

6. A video signal circuit of a computer which has a display, the video signal circuit comprising:
a north bridge chipset for generating a first analog video signal and a first digital video signal;
a VGA port configured for coupling to an external display device and a processing device which is capable of generating a second analog video signal;
a control module coupled between the north bridge and the VGA port for selectively receiving the first analog video signal of the north bridge chipset or the second analog video signal from the processing device via the VGA port;
an A/D converter coupled to the control module for receiving and converting the second analog video signal to a second digital video signal;
a selection module coupled to the north bridge chipset and the A/D converter for selectively sending one of the first and second digital video signals to the display; and
a control unit coupled to the selection module and the control module for controlling the selection module to selectively send one of the first and second digital video signals to the display;
wherein when the selection module send the first digital video signal to the display the control module receives the first analog video signal and send it to the external display device via the VGA port.
